(19) United States
(12) Patent Application Publication
(10) Pub. No.: US 2025/0205688 A1
(43) Pub. Date: Jun. 26, 2025

(54) SULFUR-FREE PLATINUM CATALYST FOR HYDROGEN PRODUCTION

(71) Applicant: The Regents of the University of California, Oakland, CA (US)

(72) Inventors: Ji Yang, Berkeley, CA (US); Sudong Chae, Berkeley, CA (US); David Prendergast, Berkeley, CA (US); Ji Su, Richmond, CA (US)

(21) Appl. No.: 18/980,051

(22) Filed: Dec. 13, 2024

Related U.S. Application Data
(60) Provisional application No. 63/612,497, filed on Dec. 20, 2023.

(51) Int. Cl. B01J 23/42; B01J 21/06; B01J 35/45; B01J 37/02; B01J 37/08; B01J 37/18; C01B 3/00

(52) U.S. Cl. CPC B01J 23/42; B01J 21/063; B01J 35/45; B01J 37/0201; B01J 37/08; B01J 37/18; C01B 3/0015

(57) ABSTRACT

This disclosure provides systems and methods related to a Pt/TiO₂ catalyst. In one aspect water with a platinum precursor dissolved therein is mixed with TiO₂ nanoparticles. The TiO₂ nanoparticles with the platinum precursor disposed thereon are heat treated in air to form platinum oxide nanoparticles disposed on the TiO₂ nanoparticles. The TiO₂ nanoparticles are deposited on a TiO₂ substrate to form a structure. The structure is reduced to form platinum nanoparticles disposed on the TiO₂ nanoparticles, including: heat treating the structure at about 375° C. to 450° C. with hydrogen being present; cooling the structure from about 375° C. to 450° C. to about 350° C. at about 2° C./minute with hydrogen being present; and cooling the structure from about 350° C. to room temperature at about 1° C./minute to 5° C./minute with hydrogen being present. After the reduction operation, the structure is heat treated in an atmosphere including methylcyclohexane.

### RELATED APPLICATIONS

This application claims priority to U.S. Provisional Patent Application No. 63/612,497, filed Dec. 20, 2023, which is herein incorporated by reference.

### STATEMENT OF GOVERNMENT SUPPORT

This invention was made with government support under Contract No. DE-AC02-05CH11231 awarded by the U.S. Department of Energy. The government has certain rights in this invention.

### BACKGROUND

The widespread use of renewable energy is critical to achieving sustainability in the energy sectors in both developing and industrialized countries. Renewable energy sources, such as solar and wind, are heavily dependent on the weather and time of day, which leads to an inconsistent energy supply. Efficient energy storage is needed for a constant renewable energy supply.

Hydrogen (H₂) is a promising energy storage candidate because it is clean (only water is generated from its combustion) and has a high gravimetric energy density (about 120 KJ/g). One issue that impedes the development of H₂ as an energy storage medium is H₂ storage. H₂ has a low volumetric energy density and is currently primarily stored or transported as compressed gas at ambient temperatures or as liquid under cryogenic conditions. To realize the potential of H₂ as a high gravimetric energy density medium, it is important to develop efficient and safe methods for on-site storage and transportation applications.

The use of liquid organic hydrogen carrier (LOHC) systems for hydrogen storage and delivery has received interest. LOHCs are fuel-like hydrocarbon compounds that reversibly bind hydrogen and enable safe, practical, and economic storage and transport of hydrogen within the existing fuel infrastructure. One of the most promising cycles is methylcyclohexane-toluene (MCH-TOL) cycle, involving dehydrogenation of MCH and hydrogenation of TOL. The MCH-TOL cycle includes a wide temperature range within which hydrogen can be stored chemically in liquid form (178 K to 373 K). To implement an efficient MCH-TOL cycle process, an active, selective, and stable catalyst for MCH dehydrogenation is needed.

Pt/Al₂O₃ is often used as a catalyst for MCH dehydrogenation. Pt/Al₂O₃, however, is readily deactivated by coke formation and suffers from low selectivity of H₂ production. Pre-sulfidation of the active metal species (i.e., Pt) has proven to be an effective strategy to suppress catalyst deactivation. A S—Pt/Al₂O₃ catalyst developed by one company has high durability (e.g., MCH conversion of greater than 95% for more than 8000 h, at 350° C., 0.3 MPa, with a liquid hourly space velocity (LHSV) of 2.0 h⁻¹). However, the addition of sulfur(S) to the catalyst may potentially cause equipment corrosion after the oxidation of sulfur forms sulfur-containing acid. Further, sulfur-containing hydrogen may poison fuel cell catalysts, which is detrimental to the normal operation of fuel cells. Additionally, the MCH-TOL system developed by the same company requires the co-feeding of H₂ (1.8% to 7.0% of all H₂) to the system when in operation to reduce carbon deposition and to maintain system stability, increasing operational costs.

### SUMMARY

The performance of the Pt/TiO₂ catalyst (with the Pt—TiO₂ interface tuned through strong metal-support interaction (SMSI)) described herein surpasses most of the existing Pt-based catalysts. The catalyst exhibited durability of MCH dehydrogenation in the absence of H₂ cofeeding and is sulfur-free. The catalyst makes the MCH-toluene cycle more cost-effective and the produced sulfur-free H₂ is useful for downstream applications (e.g., fuel cells).

One innovative aspect of the subject matter described in this disclosure can be implemented in method including mixing water with a platinum precursor dissolved therein with TiO₂ nanoparticles. The TiO₂ nanoparticles with the platinum precursor disposed thereon are heat treated in air to form platinum oxide nanoparticles disposed on the TiO₂ nanoparticles. The TiO₂ nanoparticles are deposited on a TiO₂ substrate to form a structure. The structure is reduced to form platinum nanoparticles disposed on the TiO₂ nanoparticles, including: heat treating the structure at about 375° C. to 450° C. with hydrogen being present; cooling the structure from about 375° C. to 450° C. to about 350° C. at about 2° C./minute with hydrogen being present; and cooling the structure from about 350° C. to room temperature at about 1° C./minute to 5° C./minute with hydrogen being present. After the reducing, the structure is heat treated in an atmosphere including methylcyclohexane (MCH).

Another innovative aspect of the subject matter described in this disclosure can be implemented in a method including mixing water with a platinum precursor dissolved therein with TiO₂ nanoparticles. The TiO₂ nanoparticles with the platinum precursor disposed thereon are heat treated air to form platinum oxide nanoparticles disposed on the TiO₂ nanoparticles. The TiO₂ nanoparticles are deposited on a TiO₂ substrate to form a structure. The structure is reduced to form platinum nanoparticles disposed on the TiO₂ nanoparticles, including: heating the structure to about 375° C. to 450° C. at about 10° C./minute with hydrogen being present; heat treating the structure at about 375° C. to 450° C. (or about 400° C.) for about 1 hour with hydrogen being present; cooling the structure from about 375° C. to 450° C. to about 350° C. at about 2° C./minute with hydrogen being present; and cooling the structure from about 350° C. to room temperature at about 1° C./minute to 5° C./minute with hydrogen being present. After the reducing, the structure is heat treated in an atmosphere including methylcyclohexane (MCH). The platinum nanoparticles, the TiO₂ nanoparticles, and the TiO₂ substrate substantially do not include sulfur.

In some implementation, reducing the structure forms a TiO₂₋ₓ overlayer on surfaces of the platinum nanoparticles.

Another innovative aspect of the subject matter described in this disclosure can be implemented in a method including mixing water with a platinum precursor dissolved therein with TiO₂ nanoparticles. The TiO₂ nanoparticles with the platinum precursor disposed thereon are heat treated in air to form platinum oxide nanoparticles disposed on the TiO₂ nanoparticles. The TiO₂ nanoparticles are deposited on a TiO₂ substrate to form a structure. The structure is reduced to form platinum nanoparticles disposed on the TiO₂ nanoparticles, including: heat treating the structure at about 375° C. to 450° C. (or about 400° C.) with hydrogen being present; cooling the structure from about 375° C. to 450° C. to about 350° C. at about 2° C./minute with hydrogen being present; and cooling the structure from about 350° C. to room temperature at about 1° C./minute to 5° C./minute with hydrogen being present. This reducing operation forms a TiO₂₋ₓ overlayer on surfaces of the platinum nanoparticles. After the reducing, the structure is heat treated in an atmosphere including methylcyclohexane (MCH).

In some implementation the platinum nanoparticles, the TiO₂ nanoparticles, and the TiO₂ substrate do not include or substantially do not include sulfur.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a flow diagram illustrating a manufacturing process for a sulfur-free platinum catalyst.

FIG. 2 shows an example of a graph of the dibenzyltoluene (HO-DBT) hydrogenation degree performance of the Pt/TiO₂ catalysts described herein.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

As used herein, “dispose” means “to place (things) at proper distances apart and in proper positions with regard to each other, to place suitably, adjust; to place or arrange in a particular order.”

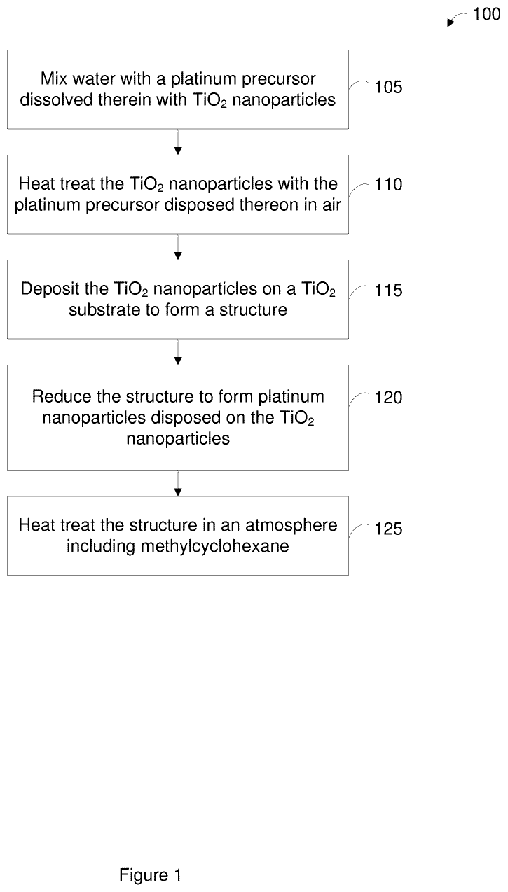

FIG. 1 shows an example of a flow diagram illustrating a manufacturing process for a sulfur-free platinum catalyst. Starting at block 105 of the method 100 shown in FIG. 1, water with a platinum precursor dissolved therein is mixed with TiO₂ nanoparticles. In some embodiments, the mixing is dropwise mixing of the water with TiO₂ nanoparticles.

In some embodiments, the mixing is performed by incipient wet impregnation. In some embodiments, incipient wet impregnation does not generate any waste water pollution. For example, a small volume of water is used to dissolve the platinum precursor. In some embodiments, the platinum precursor solution is mixed with TiO₂ nanoparticles and only the pores of the TiO₂ nanoparticles get filled with precursor solution. The mixing at block 105 results in TiO₂ nanoparticles with the platinum precursor disposed thereon. In some embodiments, the water is then be evaporated from the TiO₂ nanoparticles.

In some embodiments, the platinum precursor is or comprises chloroplatinic acid (H₂PtCl₆). In some embodiments, the TiO₂ nanoparticles have dimensions of about 15 nanometers to 25 nanometers, or about 20 nanometers.

At block 110, the TiO₂ nanoparticles with the platinum precursor disposed thereon are heat treated in air to form platinum oxide nanoparticles disposed on the TiO₂ nanoparticles. In some embodiments, the heat treating is performed at about 400° C. to 500° C. for about 2 hours to 4 hours. In some embodiments, the heat treating is performed at about 450° C. for about 3 hours. In some embodiments, the method 100 further comprises after the heat treating, cooling the TiO₂ nanoparticles with the platinum precursor disposed thereon to room temperature at about 1° C./minute to 5° C./minute.

At block 115, the TiO₂ nanoparticles are deposited on a TiO₂ substrate to form a structure.

At block 120, the structure is reduced to form platinum nanoparticles disposed on the TiO₂ nanoparticles that are disposed on the TiO₂ substrate. This reduction operation includes heat treating the structure to about 375° C. to 450° C., or at about 400° C., with hydrogen being present, cooling the structure from about 375° C. to 450° C. to about 350° C. at about 2° C./minute with hydrogen being present, and cooling the structure from about 350° C. to room temperature at about 1° C./minute to 5° C./minute with hydrogen being present. Note that “with hydrogen being present” indicates that hydrogen is in a furnace containing the structure or hydrogen is flowing around the structure during the reduction operation.

In some embodiments, the structure is heated to about 375° C. to 450° C. at about 10° C./minute with hydrogen being present during the reduction operation. In some embodiments, the structure is held at about 375° C. to 450° C. for about 1 hour.

In some embodiments, after reducing the structure, at least some of the platinum nanoparticles are embedded or half-embedded in the TiO₂ nanoparticles. In some embodiments, reducing the structure forms a TiO₂₋ₓ overlayer on surfaces of the platinum nanoparticles. In some embodiments, the TiO₂₋ₓ overlayer partially encapsulates the platinum nanoparticles.

In some embodiments, the reduction operation forms a strong metal-support interaction between platinum nanoparticles and TiO₂. For example, a platinum nanoparticle partly covered by a reduced TiOₓ overlayer may exhibit unique electronic properties.

In some embodiments, the platinum nanoparticles have dimensions of about 1 nanometer to 2 nanometers, or about 1.5 nanometers. In some embodiments, the platinum nanoparticles do not include or substantially do not include sulfur. In some embodiments, the TiO₂ nanoparticles and the TiO₂ substrate do not include or substantially do not include sulfur.

In some embodiments, the TiO₂ (i.e., both the nanoparticles and the substrate) is partially reduced to TiOₓ (0<x<2) when reducing the structure. That is, a portion of the Ti⁴⁺ is reduced to Ti³⁺. In some embodiments, the Ti³⁺/(Ti³⁺+Ti⁴⁺) ratio at the surface of the nanoparticles and the substrate is about 10% to 20%.

At block 125, the structure is heat treated in an atmosphere including methylcyclohexane (MCH). In some embodiments, this heat treatment is performed at about 300° C. to 400° C., or at about 450° C., for about 20 hours to 30 hours. This heat treatment may be referred to as a catalyst induction period. In some embodiments, the liquid hourly space velocity (LHSV) of MCH flow during this heat treatment is about 2 h⁻¹ to 5 h⁻¹. In some embodiments, the MCH is mixed with an inert gas (e.g., argon) during this heat treatment.

In some embodiments, the heat treatment at block 125 creates electron deficient platinum nanoparticles. The electron deficient platinum nanoparticles are due to electrons associated with the platinum nanoparticles being more attracted to the TiO₂. The electron deficient platinum nanoparticles catalyze the MCH dehydrogenation reaction more efficiently than metallic platinum.

In some embodiments, the method 100 shown in FIG. 1 generates a Pt nanoparticle covered by a TiOₓ overlayer with net structure or TiOₓ overlayer islands. The Pt electronic structure is modified by the reduced TiOₓ overlayer through electron transfer. The Pt/TiO₂ catalyst is a semi-core-shell structure, with Pt nanoparticles of about 1.5 nm half-embedded in TiO₂ particles. The Pt nanoparticles in the Pt/TiO₂ catalyst exhibit a high electron deficiency.

From the mechanistic viewpoint, the stabilization of Pt nanoparticles by a TiOₓ overlayer and the electron-deficient property of Pt nanoparticles is important in achieving H₂ production from MCH dehydrogenation. First, Pt nanoparticles are immobilized on the TiO₂ surface so that the Pt nanoparticles cannot move during catalysis. Second, electron-deficient Pt nanoparticles facilitate the desorption of toluene and other products, which helps to prevent coke formation that would deactivate catalysts.

Advantages of the embodiments described herein include:
No pre-sulfidation of the catalysts. In the process for fabricating the Pt/TiO₂ catalyst, neither the support nor the Pt species receives a pre-sulfidation treatment.
No H₂ cofeeding during dehydrogenation of MCH. The Pt/TiO₂ catalyst can actively, selectively, and durably dehydrogenate MCH for H₂ production without H₂ cofeeding.
No addition of a second metal species. The Pt/TiO₂ catalyst is fabricated without additional noble metals.
Industrial feasibility. The Pt/TiO₂ catalyst fabrication processes described herein are amenable to one-pot methods, which hold potential in commercial production by lowering capital expenditure.

The following examples are intended to be examples of the embodiments disclosed herein, and are not intended to be limiting.

### Example

Without the pre-sulfidation of the Pt species, the Pt/TiO₂ catalyst with a Pt weight loading of about 1% exhibited MCH dehydrogenation performance in the absence of H₂ cofeeding. Reaction conditions were as follows: catalyst mass=˜100 mg; temperature=˜350° C.; liquid hourly space velocity=˜5 h⁻¹; and pressure: ˜0.1 MPa. No catalyst deactivation was observed over about 500 h. MCH conversion of about 91% and toluene selectivity of about 100% were obtained.

### Example

In a scaled up catalytic test, H₂ production from MCH dehydrogenation could be achieved. Reaction conditions were as follows: catalyst mass=˜4 g; temperature=˜350° C.; liquid hourly space velocity=˜5 h⁻¹; and pressure: ˜0.1 MPa. No deactivation was detected over about 150 h. The Pt/TiO₂ catalyst could also be used for toluene re-hydrogenation and DBT hydrogenation.

### Example

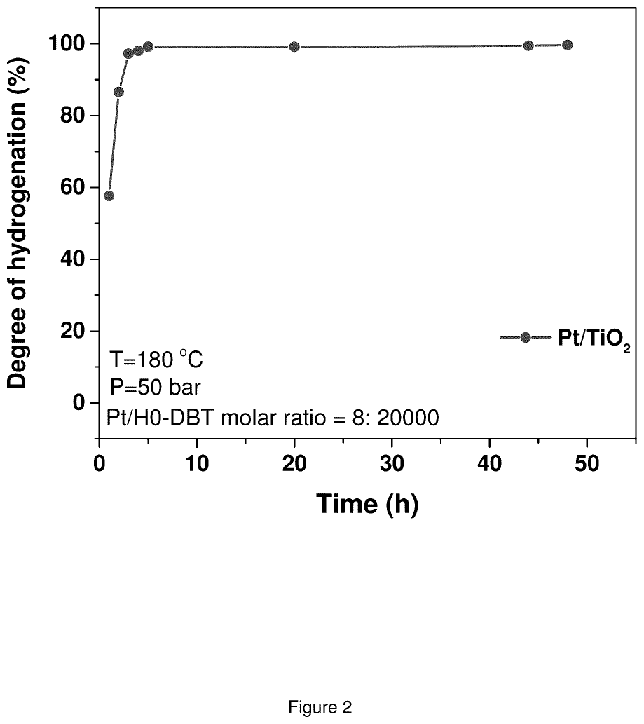

FIG. 2 shows an example of a graph of the dibenzyltoluene (HO-DBT) hydrogenation performance of the Pt/TiO₂ catalysts described herein. As shown in FIG. 2, the catalyst enabled greater than 99% hydrogenation degree of HO-DBT to perhydro-dibenzyl toluene (H18-DBT) within 8 hours of a hydrogenation process.

### CONCLUSION

A catalyst comprising Pt nanoparticles disposed on and/or embedded in titanium dioxide (Pt/TiO₂) was synthesized by the tuning metal-oxide interface. Pt nanoparticles (e.g., particle size of about 1 nm) are stabilized by a TiOₓ overlayer and are electron deficient. The Pt/TiO₂ catalyst with its geometric and electronic properties exhibits active, selective, and durable MCH dehydrogenation performance in the absence of H₂ cofeeding.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

What is claimed is:

1. A method comprising:
mixing water with a platinum precursor dissolved therein with TiO₂ nanoparticles;
heat treating the TiO₂ nanoparticles with the platinum precursor disposed thereon in air to form platinum oxide nanoparticles disposed on the TiO₂ nanoparticles;
depositing the TiO₂ nanoparticles on a TiO₂ substrate to form a structure; and
reducing the structure to form platinum nanoparticles disposed on the TiO₂ nanoparticles, including heat treating the structure at about 375° C. to 450° C. with hydrogen being present, cooling the structure from about 375° C. to 450° C. to about 350° C. at about 2° C./minute with hydrogen being present, and cooling the structure from about 350° C. to room temperature at about 1° C./minute to 5° C./minute with hydrogen being present; and
after the reducing, heat treating the structure in an atmosphere including methylcyclohexane (MCH).

2. The method of claim 1, wherein the platinum precursor is chloroplatinic acid (H₂PtCl₆).

3. The method of claim 1, wherein the mixing is dropwise mixing of the water with the TiO₂ nanoparticles.

4. The method of claim 1, wherein the mixing is performed by incipient wet impregnation.

5. The method of claim 1, wherein the TiO₂ nanoparticles have dimensions of about 15 nanometers to 25 nanometers.

6. The method of claim 1, wherein heat treating the TiO₂ nanoparticles with the platinum precursor disposed thereon is performed at about 400° C. to 500° C. for about 2 hours to 4 hours.

7. The method of claim 1, further comprising:
after heat treating TiO₂ nanoparticles with the platinum precursor disposed, cooling the TiO₂ nanoparticles to room temperature at about 1° C./minute to 5° C./minute.

8. The method of claim 1, wherein the structure is heated to about 375° C. to 450° C. at about 10° C./minute with hydrogen being present during the reducing, and wherein the structure is held at about 375° C. to 450° C. for about 1 hour.

9. The method of claim 1, wherein after reducing the structure, at least some of the platinum nanoparticles are embedded in the TiO₂ nanoparticles.

10. The method of claim 1, wherein reducing the structure forms a TiO₂₋ₓ overlayer on surfaces of the platinum nanoparticles.

11. The method of claim 1, wherein the platinum nanoparticles have dimensions of about 1 nanometer to 2 nanometers.

12. The method of claim 1, wherein the platinum nanoparticles do not include sulfur.

13. The method of claim 1, wherein the TiO₂ nanoparticles and the TiO₂ substrate do not include sulfur.

14. The method of claim 1, wherein the heat treating after the reducing is at about 300° C. to 400° C. for about 20 hours to 30 hours.

15. A method comprising:
mixing water with a platinum precursor dissolved therein with TiO₂ nanoparticles;
heat treating the TiO₂ nanoparticles with the platinum precursor disposed thereon in air to form platinum oxide nanoparticles disposed on the TiO₂ nanoparticles;
depositing the TiO₂ nanoparticles on a TiO₂ substrate to form a structure;
reducing the structure to form platinum nanoparticles disposed on the TiO₂ nanoparticles, including heating the structure to about 375° C. to 450° C. at about 10° C./minute with hydrogen being present, heat treating the structure at about 375° C. to 450° C. for about 1 hour with hydrogen being present, cooling the structure from about 375° C. to 450° C. to about 350° C. at about 2° C./minute with hydrogen being present, and cooling the structure from about 350° C. to room temperature at about 1° C./minute to 5° C./minute with hydrogen being present; and
after the reducing, heat treating the structure in an atmosphere including methylcyclohexane (MCH), the platinum nanoparticles, the TiO₂ nanoparticles, and the TiO₂ substrate substantially not including sulfur.

16. The method of claim 1, wherein reducing the structure forms a TiO₂-x overlayer on surfaces of the platinum nanoparticles.

17. The method of claim 1, wherein the heat treating after the reducing is at about 300° C. to 400° C. for about 20 hours to 30 hours.

18. A method comprising:
mixing water with a platinum precursor dissolved therein with TiO₂ nanoparticles;
heat treating the TiO₂ nanoparticles with the platinum precursor disposed thereon in air to form platinum oxide nanoparticles disposed on the TiO₂ nanoparticles;
depositing the TiO₂ nanoparticles on a TiO₂ substrate to form a structure;
reducing the structure to form platinum nanoparticles disposed on the TiO₂ nanoparticles, including heat treating the structure at about 375° C. to 450° C. with hydrogen being present, cooling the structure from about 375° C. to 450° C. to about 350° C. at about 2° C./minute with hydrogen being present, and cooling the structure from about 350° C. to room temperature at about 1° C./minute to 5° C./minute with hydrogen being present, the reducing the structure forming a TiO₂₋ₓ overlayer on surfaces of the platinum nanoparticles; and
after the reducing, heat treating the structure in an atmosphere including methylcyclohexane (MCH).

19. The method of claim 1, wherein the platinum nanoparticles, the TiO₂ nanoparticles, and the TiO₂ substrate do not include sulfur.

20. The method of claim 1, wherein the heat treating after the reducing is at about 300° C. to 400° C. for about 20 hours to 30 hours.
